(19) United States
(12) Patent Application Publication
(10) Pub. No.: US 2008/0029918 A1
(43) Pub. Date: Feb. 7, 2008

(54) Apparatus And Method For Manufacturing Plastic Products

(76) Inventor: Hendricus Antonius Hoogland, Wormer (NL)

Correspondence Address: HOFFMANN & BARON, LLP, 6900 JERICHO TURNPIKE, SYOSSET, NY, 11791, US

(21) Appl. No.: 11/663,360

(22) PCT Filed: Sep. 20, 2005
(86) PCT No.: PCT/NL05/00684

§ 371 Date: Jun. 8, 2007

(30) Foreign Application Priority Data
Sep. 20, 2004 (NL) 1027076

(51) Int. Cl. B29C 45/02

(52) U.S. Cl. 264/40.4; 425/558

(57) ABSTRACT

An apparatus (1) for the manufacture of plastic products, comprising a mold (2) in which at least one mold cavity (11) is provided in which terminates at least one runner channel (14B), wherein further a pressing device (18) is provided for operatively supplying into the runner channel an amount of at least partially plasticized plastic, and wherein between the pressing device (18) and the at least one mold cavity (11) at least one buffer chamber (13) is provided for buffering plasticized plastic (24) supplied from the pressing device (18) and in which at least one displacer member (21) is provided for pressing plasticized plastic (24) from the at least one buffer chamber (13) into the at least one mold cavity (11).

The invention relates to an apparatus for manufacturing plastic products.

For the manufacture of plastic products, usually injection molding apparatus are used, provided with a plasticizing unit and a mold with at least one mold cavity. In the plasticizing unit, an amount of plastic is plasticized by revolving a plasticizing screw in an idling manner in the plastic while heating it. Then, with the aid of the plasticizing unit, plasticized plastic is introduced under high pressure into the mold cavity of the mold and allowed to cure. Thereupon, the formed product can be taken out and, in a next injection molding cycle, a new product can be formed.

Such an apparatus has as a drawback that it is particularly heavy and complex. In particular, a heavy press is to be used to keep the or each mold cavity closed during filling. Otherwise, the mold will be pressed open by the filling pressure, which will lead to inferior products. A further drawback is that relatively great and rapid movements of parts of the plasticizing unit are required in order to obtain the desired plasticizing and pressure build-up.

One object of the invention is to provide an apparatus for manufacturing plastic products in a mold, with which at least a number of the drawbacks of the known injection molding techniques and apparatus can be obviated.

An object of the invention is in particular to provide such an apparatus which is simple in structure and use.

Another object of the invention is to provide such an apparatus which is relatively advantageous in use and particularly in use of space.

A further object of the invention is to provide an apparatus for the manufacture of plastic products with which, at relatively low pressures, a complete filling of at least one mold cavity can be obtained.

A still further object of the invention is to provide a method for manufacturing plastic products, in particular such a method in which relatively low pressures can be used.

Yet another object of the invention is to provide such a method in which a relatively simple apparatus can be used.

At least a number of these and other objects are achieved with an apparatus and method according to the invention.

With an apparatus according to the invention, use is made of a buffer chamber in which a mass of completely or partially plasticized plastic can be stored prior to it being introduced, completely or partially, into a mold cavity. Then, in order to introduce the plastic into the mold cavity, a displacer member is used, for instance a plunger, which introduces the desired mass into the mold cavity. Thus, the plasticizing unit is separated from the means for pressing the plastic into the mold and a relatively light, simple apparatus is obtained.

A further advantage of this apparatus is that, in principle, the or each buffer chamber can be built-in in a mold, so that it can be placed and removed with the mold. The pressing device which can comprise, for instance, a simple plasticizing screw or the like can therefore be universally suitable. It can furthermore be of simple design.

The or each buffer chamber is preferably designed such that plastic introduced therein is kept in plasticized condition, for instance through the provision of heating means.

It is preferred that the or each mold cavity is provided with at least one movable wall part which can be moved relatively rapidly, at least at a velocity such that plasticized plastic is kept in plasticized condition until the complete mold cavity is filled or, conversely, at a velocity such that somewhat solidified plastic is replasticized for improving the melt, at least further liquidizing the plasticized plastic. As a result of the use of such a mold, whereby, during introduction of the plastic into the mold cavity, the or a movable wall part is brought in a retracted position and is brought to an advanced position only by the end of, or after the filling of the mold cavity so that an end volume of the mold cavity for forming a desired product is reached, the advantage is achieved that particularly low filling pressures can be used, so that the mold and the associated further apparatus can be designed to be simple.

It is preferred that the mold is then laid out such that the pressure to be imposed by the or each movable wall part in the mass in the mold cavity as a result of this movement towards the advanced position, is approximately equal to the pressure exerted by the mass of the mold halves, so that the mold will simply remain closed as a result of its own mass. Surprisingly, it has appeared that as a result of the velocity of movement, which preferably leads to adiabatic heating of the mass in the mold cavity, pressures occur in the mold cavity which are relatively low with respect to pressures for manufacturing comparable products in a conventional injection molding apparatus, for instance in an order of magnitude of less than a third, more particularly less than a fourth of the customary pressures. Consequently, the mold can be held closed in a particularly simple manner. Furthermore, the auxiliary means to be used, such as a press, can be of lighter design or even be superfluous.

In an apparatus according to the invention, advantageously, more than one buffer chamber can be provided which can be connected to the same or different mold cavities. The buffer chambers can be fed from the same pressing device.

With an apparatus according to the present invention, each time during solidification of the plastic in the mold cavity, the or a buffer chamber can be filled with a new mass of completely or partially plasticized plastic so that the pressing device can plasticize plastic and feed it through the supply channel, preferably in a continuous manner. As a result, a screw, if any, in the pressing device does not need to be moved linearly, at least not at speeds so high that accelerations and decelerations of, for instance, 1 G or more occur. When using at least two buffer chambers for the same mold cavity, this advantage is enhanced still further.

With an apparatus according to the invention, preferably, use is made of a plunger or like displacer member in a buffer chamber, which plunger is under backpressure so that when the buffer chamber is being filled, the plunger is pushed away against this backpressure. Consequently, the mass fed into the buffer chamber is continuously kept under pressure so that a homogeneous mixture is obtained and/or maintained and, furthermore, air inclusions can be prevented or possibly be eliminated.

With an apparatus according to the invention, the pressure used can be kept relatively low, for instance less than 100 bar for a product which is normally formed at an injection pressure of 180 bar. By way of illustration, the plasticized mass can for instance be introduced into and kept in the buffer chamber at a pressure of approximately 30 bar, with a backpressure which is approximately the same or higher by some bars. The mold, with a mold half with a mass approximately equal to or only slightly greater than can be generated by pressure on a projected surface in the mold cavity is then held closed by its own weight. Hence, closing devices can be of particularly light design or even be omitted.

With an apparatus according to the invention, as a result of the occurring temperatures and the pressures and the short cycle time, ageing of the plastic during the process of forming is effectively prevented, at least reduced. Moreover, as a result of the low pressures in the mold, the properties are not adversely affected, not even with relatively thin products with long flow paths. The fact is that shearing and other stress factors of the molecules in the plastic are reduced to a minimum.

With an apparatus according to the invention, the mold cavity can be filled in a simple, volume-controlled manner. Here, the or each buffer chamber preferably has a volume that corresponds to the end volume of the mold cavity, i.e. the product forming volume, or an integer multiple thereof. In other words, the volume of the or each buffer chamber is equal to N*V, wherein N is an integer, a whole number and V is the product forming volume of the mold cavity. If the volume of the buffer chamber is more than one time the product forming volume, preferably, the displacing means are set for introducing into the mold cavity a volume of plasticized plastic equal to the product forming volume of the mold cavity.

The invention further relates to a method for forming plastic products, wherein a buffer chamber is utilized. As a result, a product can be formed in a simpler manner than when conventional injection molding apparatus is used.

Preferably, with a method according to the invention, during or directly after the desired mass of completely or partially plasticized plastic is fed into the mold cavity, at least one movable wall part is moved against or in the mass, such that an improvement of the melt, at least an increase of the liquidity of the mass occurs. Here, preferably, adiabatic heat development occurs in the mass.

Surprisingly, it has appeared that there is a direct connection between the frontal surface of the or each movable wall part of the mold cavity and the pressure occurring therein. Without wishing to be bound to any theory, this appears to be the result of the improvement of the melt in the mold and the velocity of movement of the or each wall part, so that a pulse is formed comparable to a pulse in water, instead of a more static pressure change as in conventional compression molding.

The kinetic energy which is introduced into the movable wall part is converted virtually completely, for instance for approximately 90%, into heat in the mass. With PP for instance, an injection temperature of 220° C. can be used. Before movement of the or each movable wall part occurs, the temperature in the mass of plastic will fall to, for instance, 207° C. Then, due to movement of the wall part, so much energy is supplied to the mass that the temperature in the mass rises to, for instance, 252° C. As a result, the melt increases from, for instance, about 38 to 45.

These values are only given by way of illustration and should not be construed as being limitative in any way.

In the subclaims, further advantageous embodiments are given.

In clarification of the invention, embodiments of an apparatus and method according to the invention are discussed and elucidated with reference to the drawing. In the drawing.

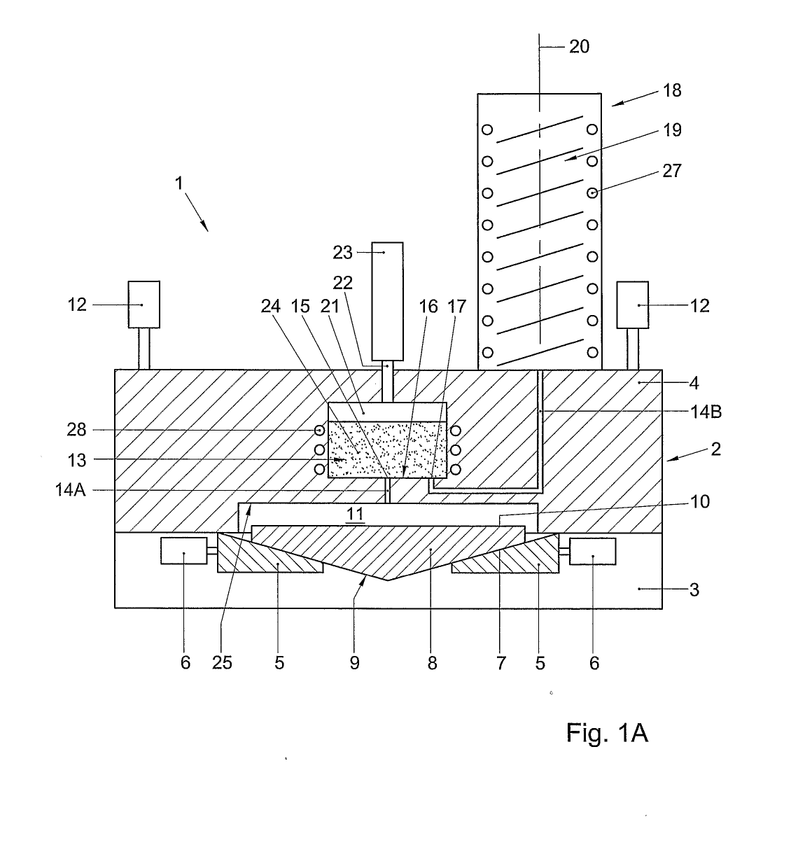

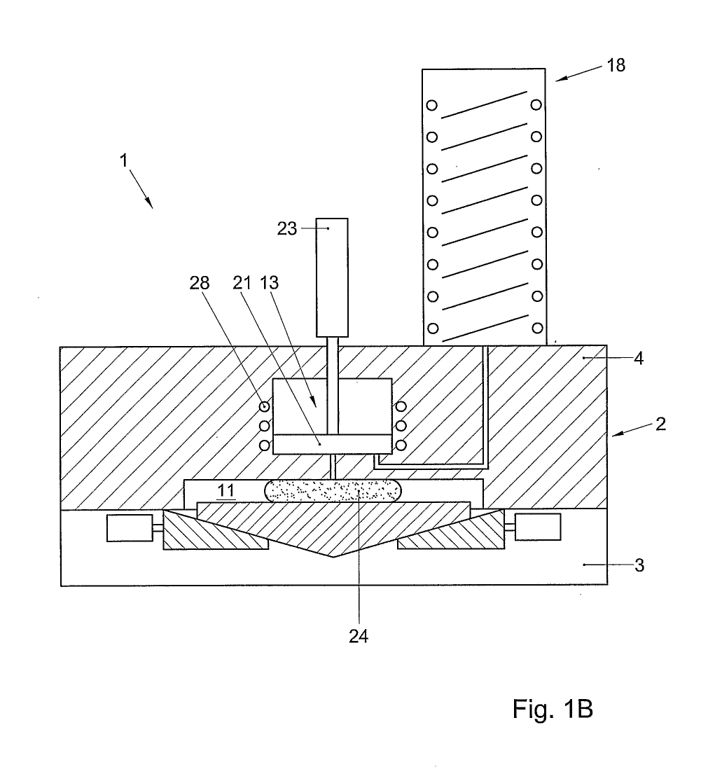

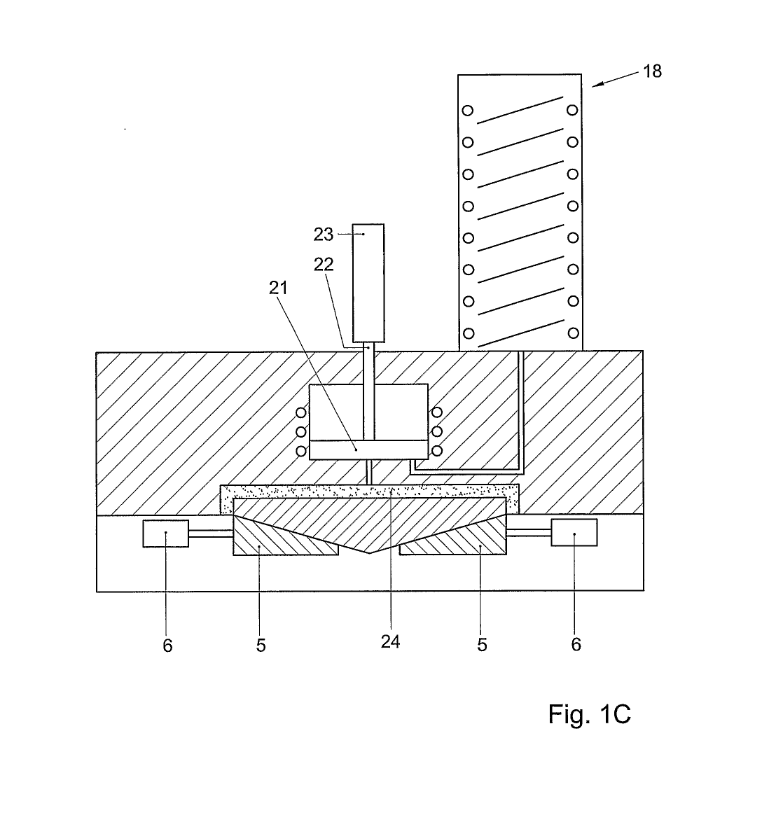

FIGS. 1A-C schematically show an apparatus according to the invention in sectional side elevation, in three different steps of a method according to the invention;

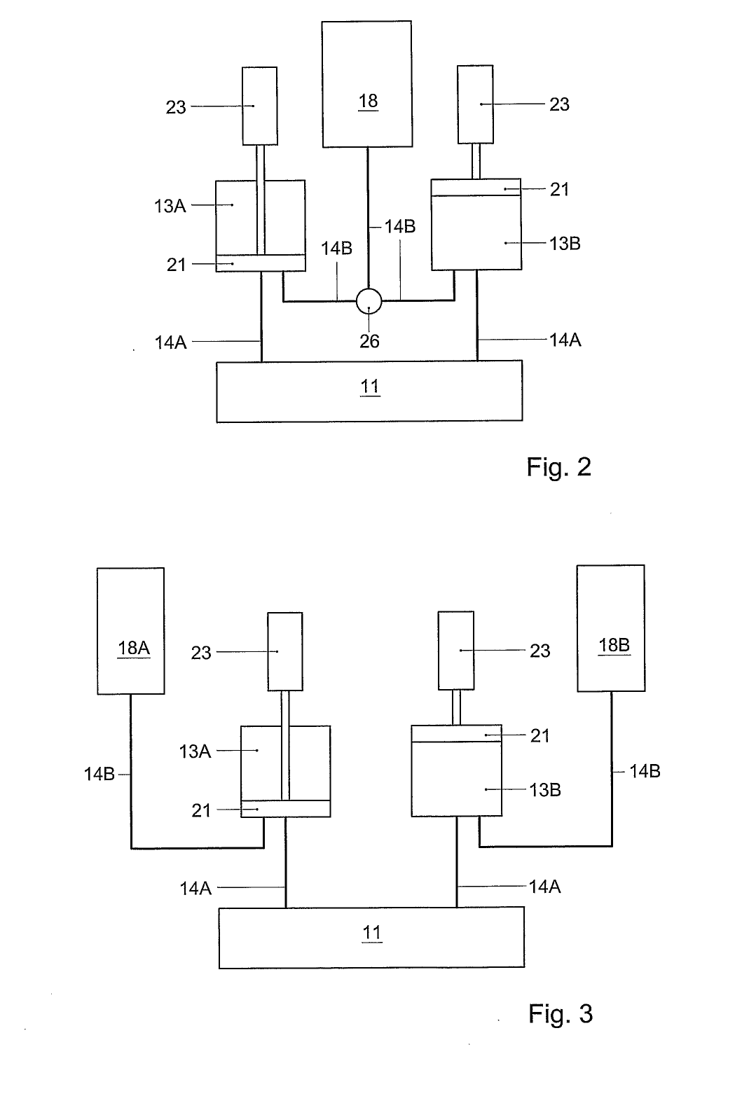

FIG. 2 schematically shows two buffer chambers with plunger and supply line according to the invention; and

FIG. 3 schematically shows a portion of an apparatus according to the invention, in an alternative embodiment.

The embodiments shown and described should not in any way be construed as limiting. They only serve by way of illustration. In the different embodiments, the same or corresponding parts are designated with the same or corresponding reference numerals.

In this description, pressing device should be understood to mean at least a device with which an at least partially plasticized mass of plastic can be displaced continuously or discontinuously. Preferably, the plastic can be plasticized in the pressing device, to which end this device can be designed as a simple plasticizing device. Incidentally, the pressing device in an apparatus according to the invention can also be designed as a conventional plasticizing unit for an injection molding apparatus.

In this description, product forming volume should be understood to mean a volume of a mold cavity which is such that the mold cavity has the shape of a product to be eventually formed in that cavity. This product can also be an intermediate product which in a successive product pass is, for instance, provided with a sprayed-on or enveloping further product part, in the same or a different mold cavity. If use is made of the same mold cavity, for instance the above-mentioned movable wall part can be retracted to a position beyond a next product forming volume, so that again a mass of a next plastic can be introduced and the or each respective movable mold part can be brought to the then-applying or intended product forming volume.

FIG. 1 schematically shows an apparatus 1 according to the invention, representing three consecutive steps.

The apparatus 1 according to FIG. 1 comprises a mold 2 with a first part 3 and a second part 4. The first part 3 rests on a substrate (not shown) and comprises two slides 5 which are movable from two mutually opposed sides, using means 6 suitable for that purpose, for instance hydraulic, pneumatic or electric means. In the embodiment shown, these are piston-cylinder assemblies. The slides 5 each have a slanting surface 7, facing up in FIG. 1. Resting on the slanting surfaces 7 is a movable wall part 8 having a complementarily beveled underside 9. The part 10 of the wall part 8 facing away from the underside 9 extends in a mold cavity 11 which is further bounded by stationary parts of the mold 2, at least with the mold closed as shown in FIG. 1. The second mold part 4 rests on the first part 3 and is retained thereon by, for instance, gravity and fitting guides (not shown). The mold cavity 11 is partly situated in the second mold part 4. Lift means such as piston-cylinder assemblies 12 or the like are provided to separate the first mold part from the second for taking out the product.

Provided in the second mold part 4 is a buffer chamber 13 situated in a supply channel 14. The supply channel 14 comprises a first channel part 14a between an outlet opening 15 in a bottom 16 of the buffer chamber 13 and the mold cavity 11, and a second channel part 14b which extends from an inlet opening 17 in the bottom 16 of the buffer chamber to a pressing device 18, schematically represented on top of the second mold part 4. This pressing device comprises a plasticizing screw 19 (schematically shown in FIG. 1A) which can rotate about a longitudinal axis 20 for plasticizing a plastic mass. Such plasticizing devices, as pressing device, are sufficiently known from practice and will not be further described here.

Provided in the buffer chamber 13 is a displacer member in the form of a piston or plunger 21, carried by a piston rod 22 of an energizing cylinder 23. This displacer member 21 is movable in a direction approximately at right angles to the bottom 16 of the buffer chamber 13.

An apparatus 1 according to FIG. 1 can be used as follows.

In the position shown in FIG. 1A, the displacer member 21 has been moved to a maximum distance from the bottom 16 and a mass of wholly or partially plasticized plastic 24 has been introduced from the pressing device 18 via the second channel part 14b into the buffer chamber. The movable wall part 8 has been moved maximally away from the opposite wall 25 of the mold cavity 11 by moving the slides 5 away from each other. As a result, the volume of the mold cavity is relatively large, larger than a product forming volume VP as shown in FIG. 1C. Preferably, the volume VB of the buffer chamber 13, at least of the mass of plastic 24 buffered therein, is equal to the product forming volume VP.

From the position shown in FIG. 1A, the displacer member 21 is moved in the direction of the bottom 16, so that the mass 24 is pressed through the first channel part 14a into the mold cavity 11, as shown in FIG. 1B. Clearly, the mold cavity is only partly filled by the plastic 24.

Next, the slides 5 are moved rapidly towards each other, so that the movable wall part 8 is pressed in the direction of the wall 25, preferably at a relatively high speed. In particular, the slides 5 are moved such that as a result of the displacement of the plastic 24 in the mold cavity 11 owing to the movement of the movable wall part 8, adiabatic heat development arises in the plastic, so that at least partial replasticization arises in the plastic. As a result, the flow properties of the plastic are improved due to the melt change and the plastic can be moved into all parts of the mold cavity substantially without pressure, at least with minimal resistance and without stress. FIG. 1C shows the end position of the movable wall part, in which the product forming volume VP of the mold cavity 11 has been reached.

In the position shown in FIG. 1C, the product formed in the mold 2 can harden through solidification of the plastic, after which the mold is opened to take out the product. Further, from the pressing device 18, again a mass of wholly or partially plasticized plastic 24 is forced into the buffer chamber 13, so that the displacer member 21 is pressed away from the bottom 16 of the buffer chamber 13. The displacer member 21 is then stalled to some extent as a result of a backpressure exerted thereon by for instance the energizing cylinder 23, which prevents air being introduced into the mass 24. As a result of this backpressure, moreover, the mass will become, at least be kept, homogeneous and any gas inclusions will be pressed out. Simultaneously with or after taking out the product, the movable wall part 8 is moved back to the position shown in FIG. 1A, so that the apparatus 1 is ready again for the next production cycle.

In an apparatus according to the invention, the feed of mass 24 into the mold cavity can be volume-controlled, so that always exactly the right filling can be obtained. Post-pressing and the like can then be omitted. Moreover, in this way, compression of the plastic in the mold cavity can be prevented, so that an optimum weight of the product is obtained. In particular, this is advantageous to the toughness of the product. However, the movable wall part can also be moved so far that the product forming volume is smaller than the introduced mass, giving rise to a certain extent of compression of the plastic. The density will thereby increase.

FIG. 2 shows a portion of an alternative embodiment of an apparatus according to the invention. In this embodiment, two buffer chambers 13A, 13B are provided, both terminating in the same mold cavity 11. Arranged between the buffer chambers 13 is a valve 26 by which a flow of plastic flowing through the second channel part 14B can be directed alternately to the first 13A and to the second buffer chamber 13B. Thus, still more easily, besides shorter cycle times, always a requisite mass of plasticized plastic 24 in one of the buffer chambers 13 can be provided for.

FIG. 3 schematically shows a portion of a further alternative embodiment of an apparatus 1 according to the invention, in which again two buffer chambers 13A, 13B are provided, both connected with the mold cavity via channel parts 14a. In this embodiment, however, each of the buffer chambers 13A, 13B is connected to a separate pressing unit 18A, 18B. With such an apparatus, two different plastics can be introduced into the same mold cavity, simultaneously and/or successively. If use is made of a mold cavity having one or more movable wall parts, first, in a manner described earlier, a first product part can be formed, after which the movable wall part 8 is retracted, thereby clearing a portion of the mold cavity, slightly larger than a second product forming volume. Next, the plastic mass from the second buffer chamber 13B can be introduced into the cavity. Next, the movable wall part 8 is moved forwards again, so that the eventual 2K product is obtained. It will be clear that in the manner shown in FIGS. 2 and 3, also more than two buffer chambers 13 can be used, optionally in combination with the embodiments shown in FIGS. 1 and 2. Also, multiple buffer chambers can be used simultaneously for filling a mold cavity via different channel parts 14a.

In the pressing device 18, in the usual manner, heating means 27 are arranged. Moreover, around the or each buffer chamber 13, second heating means 28 are arranged, with which the mass 24 in the buffer chamber can be held in plastic condition and possibly so improved. In the buffer chamber(s), the plastic 24 is always held under pressure.

By way of illustration, an example is given of pressures and temperatures in a method according to the invention, compared with a conventional injection molding method for forming a similar product.

A mass PP is introduced into the buffer chamber 13 and then introduced into the mold cavity with a temperature of about 220° C. Next, this mass cools in the mold cavity 11 to averagely about 207° C., at least near the walls of the mold cavity. Thereupon, the movable wall part 8 is moved forwards with such a speed that energy is introduced into the mass 24 which is largely converted to heat, resulting in a temperature rise to about 252° C. This yields an increase and hence an improvement of the melt from about 38 to about 45 with a corresponding lowering of the viscosity. Moreover, a more advantageous melt flow rate is obtained. The plastic 24 is for instance introduced at a pressure of about 30 bar, while the backpressure during filling of the buffer chamber is a few bars higher. By comparison, in conventional injection molding the PP is introduced into the mold cavity at the same temperature and a much higher pressure needs to be applied in order to have the plastic spread completely within the mold cavity, for instance 180 bar or higher. The plasticizing device then needs to be made of much heavier design in order to produce that desired pressure. This involves the plasticizing unit being subject to particularly high accelerations and decelerations, resulting in particularly heavy loading. Moreover, a heavy press is to be used in order for the pressure that occurs as a result of the injection pressure to be compensated in closing pressure in order to keep the mold closed. In a method according to the invention, preferably a lowest possible pressure is used, in particular less than 180, more particularly less than 100 bar and still more particularly less than 60 bar. It has been found that injection pressures are possible of less than 50 bar, for instance about 30 bar, while conventional injection molding necessitates pressures of 180 bar or higher for forming a comparable product. Moreover, with a method according to the invention, a lower shot weight can suffice for obtaining a product of the same volume.

In an apparatus according to the invention, incidentally, a conventional plasticizing unit and press can be used, for instance if a mold cavity without movable wall part is used.

In a method according to the invention, the volume of the or each buffer chamber 13 may be equal to the product forming volume of the mold cavity, but it may also be a multiple thereof, in particular an integer multiple. The displacer member 21 can then be so controlled that always the desired volume of the mass 24 is introduced into the mold cavity, in particular in agreement with the product forming volume VP.

The invention is not limited in any way to the exemplary embodiments shown in the description and the drawing. Many variations thereon are possible within the scope of the invention outlined by the claims.

Thus, other means can be used to empty and/or fill the buffer chamber, while moreover the backpressure can be provided in a different manner, for instance by a hydraulic or pneumatic buffer, electrical means or the like. A mold cavity can be used having other and/or more movable wall parts. Moreover, for instance movable cores, inserts and the like can be used in such a mold. Also, multiple molds can be used in an apparatus or method according to the invention. In particular, all combinations of parts of the different embodiments are understood to be included and disclosed in this description.

1. An apparatus for the manufacture of plastic products, comprising a mold in which at least one mold cavity is provided in which terminates at least one runner channel, wherein further a pressing device is provided for operatively supplying into the runner channel an amount of at least partially plasticized plastic and wherein between the pressing device and the at least one mold cavity at least one buffer chamber is provided for buffering plasticized plastic supplied from the pressing device and in which at least one displacer member is provided for pressing plasticized plastic from the at least one buffer chamber into the at least one mold cavity.

2. An apparatus according to claim 1, wherein the at least one mold cavity has a first volume in a first product forming, closed position and wherein the at least one buffer chamber has a buffer volume which is at least equal to the first volume, more particularly equal to a discrete number of times said first volume and preferably equal to the first volume.

3. An apparatus according to claim 1, wherein the at least one mold cavity comprises at least one movable wall part for determining said first volume, which wall part is retractable to a position in which the respective mold cavity has a second volume, larger than said first volume.

4. An apparatus according to claim 1, wherein said pressing device comprises said displacer member.

5. An apparatus according to claim 1, wherein the pressing device comprises a plasticizing screw.

6. An apparatus according to claim 1, wherein the or each buffer chamber comprises heating means.

7. An apparatus according to claim 1, wherein the or each displacer member comprises a backpressure-device for pressing a plunger of the displacer member against the mass flowing into a respective buffer chamber during the filling thereof.

8. An apparatus according to claim 1, wherein at least two buffer chambers are provided and wherein between the pressing device and the at least two buffer chambers at least one valve is provided with which alternately one buffer chamber and the other buffer chamber can be set into open communication with the pressing device.

9. An apparatus according to claim 1, wherein at least two buffer chambers are provided, while from each of the buffer chambers an inlet channel part extends into one mold cavity.

10. An apparatus according to claim 1, wherein the pressing device is arranged for introducing a plasticized plastic into the or each buffer chamber with a pressure of less than 180 bar, more particularly less than 100 bar and preferably less than 60 bar.

11. An apparatus according to claim 10, wherein the pressing device is arranged for introducing a plasticized plastic into the or each buffer chamber with a pressure of less than 50 bar, in particular about 30 bar.

12. An apparatus according to claim 1, wherein the or each mold cavity contains a movable wall part which is movable in the mold cavity with such a speed that an amount of plastic provided in the mold cavity is at least partially replasticized.

13. An apparatus according to claim 1, wherein each mold cavity contains a movable wall part which is movable in the mold cavity with such a speed that an amount of plastic provided in the mold cavity is at least partly compressed.

14. An apparatus according to claim 12, wherein said movable wall parts are arranged for moving so fast that said plastic is compressed during the generation of adiabatic heating.

15. A method for manufacturing a plastic product in a mold cavity, wherein an amount of wholly or partially plasticized plastic is introduced into a mold cavity, which plastic is plasticized wholly or partially in a pressing device and is then introduced into at least one buffer chamber, from which buffer chamber an amount, in particular the amount, of plastic is introduced into the mold cavity using a displacer member such as a plunger.

16. A method according to claim 15, wherein said amount of plastic is introduced into the buffer chamber under backpressure, such that gas inclusions in the plastic are prevented or displaced.

17. A method according to claim 16, wherein the plastic in the buffer chamber is brought into and/or held in a homogeneous condition.

18. A method according to claim 15, wherein the plastic is introduced into the at least one mold cavity in a volume-controlled manner.

19. A method according to claim 15, wherein the plastic is introduced into a mold cavity of a closed mold, of which mold cavity at least one wall part is formed for at least a portion by a movable wall part which during introduction into the mold cavity of at least a portion of the plastic has been brought into a retracted position, such that the respective mold cavity has a relatively large volume, and next is brought into a forwardly moved position for determining an eventual, product determining volume, whilst displacing at least a portion of the plastic in the mold cavity.

20. A method according to claim 19, wherein the volume of plastic introduced into the mold is equal to the product determining volume.

21. A mold for use in an apparatus according to claim 1, wherein in the mold a supply channel is provided in which at least one buffer chamber is included for buffering a wholly or partially plasticized mass of plastic.

22. A mold according to claim 21, wherein at least one mold cavity is provided with at least one movable wall part, by which, with the mold closed, the volume of the mold cavity can be reduced to a product forming volume.

23. A method according to claim 15, wherein in the mold a supply channel is provided in which at least one buffer chamber is included for buffering a wholly or partially plasticized mass of plastic.
